(19) United States
(12) Patent Application Publication
(10) Pub. No.: US 2020/0330961 A1
(43) Pub. Date: Oct. 22, 2020

(54) BIOMIMETIC WATER OXIDATION CATALYSTS

(71) Applicants: THE AUSTRALIAN NATIONAL UNIVERSITY, Acton, ACT (AU); UNIVERSITY OF WOLLONGONG, New South Wales (AU)

(72) Inventors: Ronald John PACE, Crescent Farrer, ACT (AU); Robert STRANGER, Nicholls, ACT (AU); Gerhard Frederick SWIEGERS, Superior, CO (US); Danijel BOSKOVIC, Hawthorn (AU)

(21) Appl. No.: 16/955,997

(22) PCT Filed: Dec. 19, 2018
(86) PCT No.: PCT/AU2018/051365

§ 371 Date: Jun. 19, 2020

(30) Foreign Application Priority Data
Dec. 19, 2017 (AU) 2017905074

(51) Int. Cl. B01J 21/18; B01J 23/02; B01J 23/34; C25B 11/04; B01J 35/00; C25B 1/04; B01J 37/02; B01J 37/34

(52) U.S. Cl. CPC B01J 21/185; B01J 23/02; B01J 23/34; C25B 11/0489; B01J 37/348; B01J 35/0033; C25B 1/04; B01J 37/024; B01J 35/0006

(57) ABSTRACT

Disclosed herein is a composite material comprising a graphene-based material, manganese oxide, and group II metal ions. The graphene based material may be functionalised with an organic moiety comprising an acidic functional group. The composite material may function as a catalyst for electrolysis of water.

### FIELD

The present invention relates to composite materials having catalytic activity in the electrolytic oxidation of water.

### BACKGROUND

Hydrogen as Fuel.

Hydrogen is “the fuel of the future” because it is abundant, as a component of water, and benign in terms of emissions. It holds tremendous promise as an indefinitely renewable liquid fuel. Hydrogen can be used in fuel cells or directly combusted for transportation or power generation. Portable applications include consumer electronics or auxiliary power units. In transportation, hydrogen can power fuel cells or be burned directly in appropriately adapted internal combustion engines. Finally, hydrogen fuel cells can be used for power generation at remote locations, in backup power units for conventional power plants or as stand-alone, stationary power plants. Global hydrogen production is currently derived from natural gas (48%), oil (30%), coal (18%) and electrolysis of water (4%). As hydrogen is currently sourced mostly from fossil fuels, a sustainable “hydrogen economy” must shift away from these inputs and extract hydrogen from water. This can be achieved by electrolysis.

Photosynthesis.

Plants use sunlight to split water to form hydrogen (as protons) and oxygen within photosynthesis. The step of converting two water molecules to an oxygen molecule and four protons occurs within the Oxygen Evolving Complex (OEC) in Photosystem II (PS-II), a catalytic centre comprising of an oxo-bridged, cubical CaMn₄O₄ cluster (see FIG. 1). Co-factors associated with the OEC, include, most notably, a redox-active tyrosine (Y_{z}), which mediates electron transfer between the Mn₄Ca cluster and the chlorophyll P680 reaction centre where photo-activated, primary charge separation occurs. Strontium may also replace calcium in the PSII-OEC, while retaining full function. The PSII-OEC is photo-assembled from 4 Mn^{II} ions and apo-protein, then operates cyclically through a series of four quasi-stable intermediates. The chemistry performed by the OEC is remarkable for being: (i) fast (˜1000 turnover s⁻¹), (ii) thermodynamically efficient (over-voltage<0.3 V) and (iii) based on earth-abundant elements (Mn, Ca). The OEC is, by a large margin, the most efficient known catalyst of water oxidation under neutral conditions. For these reasons, there is substantial interest in mimicking the actions and performance of the PSII-OEC.

Bio-Inspiration in Water Oxidation Catalysis.

Numerous studies have been performed, aiming to mimic, in some measure, water oxidation catalysis by the PSII-OEC. Many have involved the use of sacrificial chemical oxidants, such as Ce⁴⁺, to cycle and turnover the catalysts. Others have sought to achieve turnover by direct electrochemical electron transfer. While interesting and important advances have been made in this field, the key principles needed to guide bio-inspiration in respect of water oxidation catalysis, have generally remained unclear.

In view of the above, a synthetic mimic of PSII-OEC which can be utilised for the efficient electrolysis of water would be highly desirable.

An object of the present invention is to provide a material having catalytic activity in the electrolytic oxidation of water. Another object of the present invention is to provide a material which is suitable for facilitating the electrolytic oxidation of water, when used as the anode in an electrolytic cell.

### SUMMARY OF INVENTION

In a first aspect of the invention, there is provided a composite material comprising a graphene-based material, manganese oxide, and group II metal ions.

The following options may be used in conjunction with the first aspect, either individually or in any suitable combination.

The group II metal ions may be Ca²⁺ ions, Sr²⁺ ions, or a mixture thereof.

The manganese oxide may be amorphous.

The graphene-based material may comprise any one or more of graphene, reduced graphene oxide, liquid crystalline reduced graphene oxide, basal plane pyrolytic graphite and carbon nanotubes. The graphene-based material may have a thickness of about 0.1 to about 1000 μm. The graphene-based material may have a conductance of about 100 to about 500 S/cm

The graphene-based material may be functionalised with an organic moiety comprising an acidic functional group. The graphene-based material may be functionalised with an organic moiety comprising an acidic functional group at an edge of the graphene-based material, to provide edge functionalised graphene-based material. The organic moiety may be an amino acid. The amino acid may be tyrosine or glutamate. The amino acid may be an aminoalkanoic acid. The organic moiety may be an aminophenol or an aminobenzoic acid.

The composite material may be disposed as a layer on a substrate. The substrate may comprise an electrically conductive material which is in contact with the graphene-based material. In one embodiment, the electrically conductive material may be a film. The substrate may further comprise an electrically non-conductive material and the film is disposed thereon. The electrically non-conductive material may be poly(ethylene terephthalate). The film may comprise copper, silver, aluminium, nickel, stainless steel, or a mixture thereof. In an alternative embodiment, the electrically conductive material may be a metal mesh. The metal may be nickel or stainless steel.

In one embodiment there is provided a composite material comprising liquid crystalline reduced graphene oxide, amorphous manganese oxide, and group II metal ions, for example Ca²⁺ ions or Sr²⁺ ions.

In another embodiment there is provided a composite material comprising liquid crystalline reduced graphene oxide, amorphous manganese oxide, and group II metal ions, for example Ca²⁺ ions or Sr²⁺ ions, wherein said composite material is disposed as a layer on a substrate. The substrate may comprise an electrically non-conductive material. The substrate may additionally or alternatively comprise an electrically conductive material.

In another embodiment there is provided a composite material comprising liquid crystalline reduced graphene oxide, amorphous manganese oxide, and group II metal ions, for example Ca²⁺ ions or Sr²⁺ ions, wherein said composite material is disposed as a layer on a substrate, the substrate comprising an electrically conductive material in the form of a film. The film may be disposed between an electrically non-conductive material and the composite material layer and may be in physical contact with the liquid crystalline reduced graphene oxide.

In another embodiment there is provided a composite material comprising liquid crystalline reduced graphene oxide, amorphous manganese oxide, and group II metal ions, for example Ca²⁺ ions or Sr²⁺ ions, wherein said composite material is disposed as a layer on a substrate, the substrate comprising an electrically conductive material which is a metal mesh. The metal mesh may in physical contact with the liquid crystalline reduced graphene oxide.

In another embodiment there is provided a composite material comprising liquid crystalline reduced graphene oxide, amorphous manganese oxide, and group II metal ions, for example Ca²⁺ ions or Sr²⁺ ions, wherein said composite material is disposed as a layer on a substrate, the substrate comprising an electrically conductive material, and wherein the liquid crystalline reduced graphene oxide is functionalised with an organic moiety comprising an acidic functional group.

In another embodiment there is provided a composite material comprising liquid crystalline reduced graphene oxide, amorphous manganese oxide, group II metal ions, for example Ca²⁺ ions or Sr²⁺ ions, and a second graphene-based material which is functionalised with an organic moiety comprising an acidic functional group, wherein said composite material is disposed as a layer on a substrate, the substrate comprising an electrically conductive material. The second graphene-based material may be disposed on an upper (i.e. away from the substrate) surface of the liquid crystalline reduced graphene oxide.

In another embodiment there is provided a composite material comprising liquid crystalline reduced graphene oxide, amorphous manganese oxide, and group II metal ions, for example Ca²⁺ ions or Sr²⁺ ions, wherein said composite material is disposed as a layer on a substrate, the substrate comprising an electrically conductive material which is a film. The film may be disposed between an electrically non-conductive material and the layer. The liquid crystalline reduced graphene oxide may be functionalised with an organic moiety comprising an acidic functional group. The film may be in contact with the liquid crystalline reduced graphene oxide.

In another embodiment there is provided a composite material comprising liquid crystalline reduced graphene oxide, amorphous manganese oxide, and group II metal ions, for example Ca²⁺ ions or Sr²⁺ ions, wherein said composite material is disposed as a layer on a substrate, the substrate comprising an electrically conductive material which is a metal mesh, and wherein the liquid crystalline reduced graphene oxide is functionalised with an organic moiety comprising an acidic functional group. The mesh may be in contact with the liquid crystalline reduced graphene oxide.

In another embodiment there is provided a composite material comprising liquid crystalline reduced graphene oxide, amorphous manganese oxide, group II metal ions, for example Ca²⁺ ions or Sr²⁺ ions, and a second graphene-based material which is functionalised with an organic moiety comprising an acidic functional group, wherein said composite material is disposed as a layer on a substrate, the substrate comprising an electrically conductive material which is a film. The film may be disposed between an electrically non-conductive material and the composite material layer and be in physical contact with the liquid crystalline reduced graphene oxide.

In another embodiment there is provided a composite material comprising liquid crystalline reduced graphene oxide, amorphous manganese oxide, group II metal ions, for example Ca²⁺ ions or Sr²⁺ ions, and a second graphene-based material which is functionalised with an organic moiety comprising an acidic functional group, wherein said composite material is disposed as a layer on a substrate, the substrate comprising a metal mesh. The metal mesh may be in physical contact with the liquid crystalline reduced graphene oxide.

In another embodiment there is provided a composite material comprising edge functionalised graphene functionalised with an organic moiety comprising an acidic functional group, amorphous manganese oxide, and group II metal ions, for example Ca²⁺ ions or Sr²⁺ ions, wherein said composite material is disposed as a layer on a substrate, the substrate comprising an electrically conductive material which is a metal mesh. The organic moiety may be an aminobenzoic acid. The organic moiety may be tyrosine. The organic moiety may be an aminoalkanoic acid. The mesh may be in contact with the edge functionalised graphene.

In a second aspect of the invention, there is provided a method of producing a composite material, the method comprising:
a. Applying a graphene-based material to a substrate,
b. Treating the product of step a. with group II metal ions, and
c. Applying manganese oxide to the product of step b.

The following options may be used in conjunction with the first aspect, either individually or in any suitable combination.

The group II metal ions may be Ca²⁺ ions, Sr²⁺ ions, or a mixture thereof.

Step c. may be such that the applied manganese oxide is amorphous.

The graphene-based material may comprise any one or more of graphene, reduced graphene oxide, liquid crystalline reduced graphene oxide, basal plane pyrolytic graphite or carbon nanotubes.

Step a. may comprise dip-coating said substrate. Step a. may be such that the applied graphene-based material has a thickness of about 0.1 to about 1000 μm. Step a. may be such that the applied graphene-based material has a conductance of about 100 to about 500 S/cm

Step b. may comprise immersing the product of step a. in an aqueous solution comprising group II metal ions.

Step c. may comprise electrodeposition of manganese oxide onto said surface.

The method may further comprise functionalising the graphene-based material with an organic moiety comprising an acidic functional group. Said functionalising with an organic moiety comprising an acidic functional group may comprise covalently attaching an organic molecule comprising an acidic functional group to the graphene-based material. In one embodiment, said covalently attaching may occur at an edge of the graphene-based material to provide edge functionalised graphene-based material. In an alternative embodiment, said covalently attaching the organic molecule may comprise attaching an amine linker molecule to the graphene-based material through a diazonium coupling, followed by attachment of the organic molecule comprising an acidic functional group to said linker molecule by an amide coupling. The organic moiety or molecule may be an amino acid. The amino acid may be tyrosine or glutamate. The amino acid may be an aminoalkanoic acid. The organic moiety or molecule may be an aminophenol or an aminobenzoic acid.

The substrate may comprise an electrically conductive material which is in contact with the graphene-based material. In one embodiment, the electrically conductive material may be a film. The substrate may further comprise an electrically non-conductive material and the film is disposed thereon. The electrically non-conductive material may be poly(ethylene terephthalate). The film may comprise copper, silver, aluminium, nickel, stainless steel, or a mixture thereof. In an alternative embodiment, the electrically conductive material may be a metal mesh. The metal may be nickel or stainless steel.

In one embodiment there is provided a method of producing a composite material, the method comprising applying liquid crystalline reduced graphene oxide to a substrate comprising poly(ethylene terephthalate), treating the liquid crystalline reduced graphene oxide with group II metal ions, for example Ca²⁺ ions or Sr²⁺ ions, and applying manganese oxide to the graphene-based material.

In another embodiment there is provided a method of producing a composite material, the method comprising applying liquid crystalline reduced graphene oxide to a substrate comprising poly(ethylene terephthalate) and an electrically conductive film on a surface thereof, treating the liquid crystalline reduced graphene oxide with group II metal ions, for example Ca²⁺ ions or Sr²⁺ ions, and applying manganese oxide to the graphene-based material.

In another embodiment there is provided a method of producing a composite material, the method comprising applying liquid crystalline reduced graphene oxide to a substrate comprising poly(ethylene terephthalate), treating the resulting material with group II metal ions, for example Ca²⁺ ions or Sr²⁺ ions, and applying manganese oxide to the resulting material, wherein the liquid crystalline reduced graphene oxide is functionalised with an organic moiety comprising an acidic functional group.

In another embodiment there is provided a method of producing a composite material, the method comprising applying liquid crystalline reduced graphene oxide to a substrate comprising a metal mesh, treating the resulting material with group II metal ions, for example Ca²⁺ ions or Sr²⁺ ions, and applying manganese oxide to the resulting material, wherein the liquid crystalline reduced graphene oxide is functionalised with an organic moiety comprising an acidic functional group.

In another embodiment there is provided a method of producing a composite material, the method comprising applying liquid crystalline reduced graphene oxide to a substrate comprising poly(ethylene terephthalate) and an electrically conductive film on a surface thereof; applying a second graphene-based material to the resulting material, wherein the second graphene-based material is functionalised with an organic moiety comprising an acidic functional group; treating the resulting material with group II metal ions, for example Ca²⁺ ions or Sr²⁺ ions; and applying manganese oxide to the resulting material.

In another embodiment there is provided a method of producing a composite material, the method comprising applying liquid crystalline reduced graphene oxide to a substrate comprising a metal mesh; applying a second graphene-based material to the resulting material, wherein the second graphene-based material is functionalised with an organic moiety comprising an acidic functional group; treating the resulting material with group II metal ions, for example Ca²⁺ ions or Sr²⁺ ions; and applying manganese oxide to the resulting material.

In another embodiment there is provided a method of producing a composite material, the method comprising knife-coating a mixture of liquid crystalline graphene oxide and hypophosphorous acid onto a substrate comprising poly(ethylene terephthalate), immersing the resulting material in an aqueous calcium chloride solution, and electrodepositing manganese oxide onto the resulting material.

In another embodiment there is provided a method of producing a composite material, the method comprising knife-coating a mixture of liquid crystalline graphene oxide and hypophosphorous acid onto a substrate comprising poly(ethylene terephthalate) and a copper film on a surface thereof, immersing the resulting material in an aqueous calcium chloride solution, and electrodepositing manganese oxide onto the resulting material.

In another embodiment there is provided a method of producing a composite material, the method comprising dip-coating a mixture of liquid crystalline graphene oxide onto a substrate comprising a metal mesh followed by reduction, then immersing the resulting material in an aqueous calcium chloride solution, and electrodepositing manganese oxide onto the resulting material.

In another embodiment there is provided a method of producing a composite material, the method comprising applying a mixture of edge functionalised graphene, wherein the edge-functionalised graphene is functionalised with an organic moiety comprising an acidic functional group, onto a substrate comprising a metal mesh, then immersing the resulting material in an aqueous calcium chloride solution, and electrodepositing manganese oxide onto the resulting material.

In a third aspect of the invention, there is provided a composite material produced by the method of the second aspect of the invention.

In a fourth aspect of the invention, there is provided an electrode comprising the composite material of any one of the first or third aspects of the invention.

In a fifth aspect of the invention, there is provided a method of electrolysing water, the method comprising at least partially immersing the electrode of the fourth aspect of the invention and a counter electrode in an aqueous solution and applying a voltage between said electrodes.

In a sixth aspect of the invention, there is provided a use of the composite material of the first or third aspects of the invention in the fabrication of an electrode.

In a seventh aspect of the invention, there is provided a use of the electrode of the fourth aspect of the invention for the electrolysis of water.

In an eighth aspect of the invention, there is provided a method of generating H₂, the method comprising at least partially immersing the electrode of the fourth aspect of the invention and a counter electrode in an aqueous solution and applying a voltage between said electrodes.

### BRIEF DESCRIPTION OF DRAWINGS

FIG. 1. A side view of the CaMn₃O₄ core of the CaMn₄O₄ cluster of the Photosystem II Oxygen Evolving Complex (PSII-OEC) showing the putative cubane structural motif.

FIG. 2. A schematic representation of a procedure for the covalent attachment of an organic molecule comprising an acidic functional group to the graphene-based material.

FIG. 3. Linear sweep voltammograms (vs Ag/AgCl) in 0.1 M Na₂SO₄ of: (a) Ca-containing MnOₓ—Ca-RLCGO-PET with 5 min electrodeposition time, (b) Ca-free MnOₓ-RLCGO-PET with 5 min electrodeposition time), (c) Ca-free and Mn-free RLCGO-PET (d) MnOₓ electrodeposited on FTO, (e) control Pt-PET, and (f) internal resistance-corrected Ca-containing MnOₓ—Ca-RLCGO-PET with 5 min electrodeposition time.

FIG. 4. Chronoamperograms at 1.15 V (vs Ag/AgCl) in 0.1 M Na₂SO₄ of: (a) MnOₓ-Ca-RLCGO-PET (5 min electrodeposition time), (b) MnOₓ-RLCGO-PET (5 min electrodeposition time), and (c) control Pt-PET.

FIG. 5. Chronoamperograms at 1.6 V (vs Ag/AgCl) in 0.1 M Na₂SO₄ of: (a) Ca-containing MnOₓ—Ca-RLCGO-PET (5 min electrodeposition time), (b) Ca-free MnOₓ-RLCGO-PET (5 min electrodeposition time), (c) Ca-free and Mn-free RLCGO-PET (d) MnOₓ electrodeposited on FTO, and (e) control Pt-PET.

FIG. 6. Diagram of an active electrode area with length, L=2 cm, width W=2 cm.

FIG. 7. Linear sweep voltammogram data of composite materials according to the invention. (a) Internal resistance-corrected Ca-containing MnOₓ—Ca-RLCGO-PET with 5 min electrodeposition time. (b) Control Pt-PET. (c) Ca-free and Mn-free RLCGO-PET. (d) OEC Catalyst equivalent performance at 10¹⁴ sites/cm² density. (e) OEC Catalyst equivalent performance at 10¹⁵ sites/cm² density.

FIG. 8. Linear sweep voltammogram data of composite materials according to the invention. Electrodes on nickel substrates: (a) Chemically reduced RLCGO-MnOₓ (15 min deposition time) on Ni mesh (b) MnOₓ (10 min deposition time) on Ni mesh (c) LCGO-MnOₓ (10 min deposition time) on Ni mesh (d) Heat reduced RLCGO-MnOₓ (5 min deposition time) on Ni mesh (e) Ni mesh (f) LCGO-MnOₓ (5 min deposition time) on Ni foil (g) Heat reduced RLCGO-MnOₓ (5 min deposition time) on Ni foil.

FIG. 9. Linear sweep voltammogram data of composite materials according to the invention. Comparison of substrates. A. (a) Chemically reduced RLCGO-MnOₓ (15 min deposition time) on Ni mesh (b) Ca-LCGO-MnOₓ (15 min deposition time) on steel mesh (c) MnOₓ (5 min deposition time) on steel mesh (d) Ca-RLCGO-MnOₓ (10 min deposition time) on PET. B. (i) Ca-RLCGO-MnOₓ (10 min deposition time) on steel mesh v Ca-RLCGO-MnOₓ (10 min deposition time) on PET (ii) Expansion of (i) between 0.8 and 1.6 V.

FIG. 10. Current Density vs Voltage for Ni mesh with functionalised RGO/MnOx systems. Comparison of substrates. (i) Ni mesh+RGO (ii) Ni mesh+RGO MnOₓ (iii) Ni mesh+RGO+4-aminophenol MnOₓ (iv) Ni mesh+RGO+3-aminobenzoic acid MnOₓ.

FIG. 11. Current Density vs Voltage for Ni mesh with EFG/MnOₓ systems. Comparison of substrates. (i) Ni EFG (ii) Ni EFG MnOₓ (iii) Ni EFG benzoic acid MnOₓ.

FIG. 12. Photographs showing typical appearance of (a) RLCGO-PET and Ca-RLCGO-PET electrodes; (b) MnOₓ-Ca-RLCGO-PET electrodes (2.5 min (left) and 5 min (right) electrodeposition time) (c) Electrode comprising RLCGO-MnOₓ (15 min deposition time) on Ni mesh being tested in an electrochemical cell, producing bubbles of oxygen gas.

FIG. 13. Current Density vs Voltage for Ni mesh with functionalised RGO/MnOx compared with Ni foil EFG systems—(a) Ni mesh, (b) Ni mesh chemically reduced RLCGO, (c) Ni mesh chemically reduced RLCGO MnOₓ (15 min deposition time), (d) Ni foil EFG 20 mg/mL, (e) Ni foil EFG 20 mg/mL, MnOₓ (20 min deposition time), (f) Ni foil EFG functionalised with aminobenzoic acid 20 mg/mL, (g) Ni foil EFG functionalised with aminobenzoic acid 20 mg/mL, MnOₓ (20 min deposition time), (h) Ni foil EFG 10 mg/mL+goretex, MnOₓ (15 min deposition time).

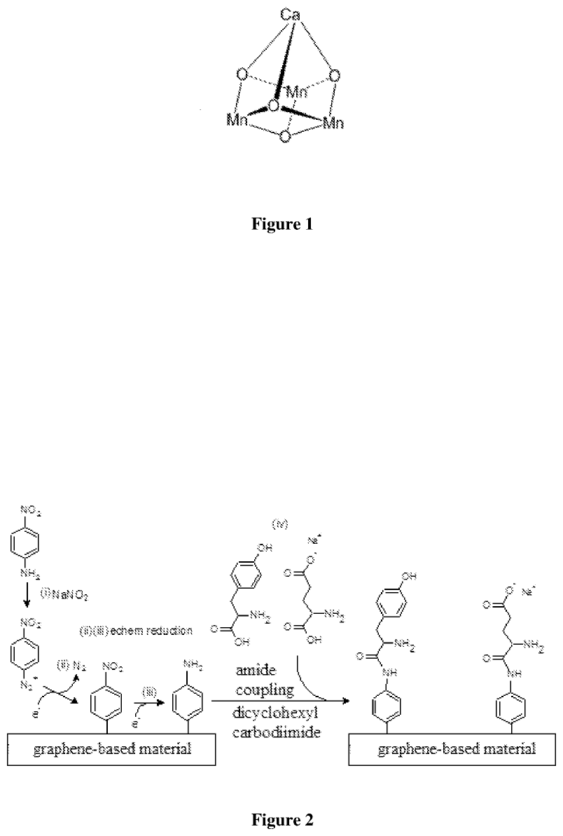

### ABBREVIATIONS

RGO: reduced graphene oxide

RLCGO: reduced liquid crystalline graphene oxide

LGCO: liquid crystalline graphene oxide

EFG: edge functionalised graphene

PET: poly(ethylene terephthalate)

MnOₓ: manganese oxide

PSII-OEC: photosystem II—oxygen evolving complex

FRGO: functionalised reduced graphene oxide

### DESCRIPTION OF EMBODIMENTS

The present specification relates to a composite material which may be used to facilitate the electrolytic oxidation of water when used as the anode in an electrolytic cell.

The inventors have unexpectedly found that important components in the PSII-OEC are the Ca cap and the Mn(4) ion of the CaMn₄O₄ cluster. These species appear to facilitate the step of O—O bond formation, which may further rely on coupled e⁻/H⁺ transfer to the phenoxyl O of an oxidised tyrosine group. The inventors have proposed that to mimic the action of the PSII-OEC, non-biological man-made systems should contain closely proximate, co-located, Ca and Mn oxide species, with a nearby conducting, organic material capable of facilitating ready electron transfer. Ca may also be replaced by Sr in the composite material of the invention.

Surprisingly, the inventors have found that an electrode fabricated from a composite material designed to mimic PSII-OEC according to the above principles exceeds the activity of an industrial standard platinum electrode in the electrolytic oxidation of water. It is suggested that the catalytic efficiency of the PSII-OEC may be replicated by co-locating Ca²⁺ ions or Sr²⁺ ions in close proximity to a manganese oxide layer, which is, in turn, proximate to a conducting organic species capable of facilitating electron transfer.

The composite material of the invention comprises a graphene-based material, Ca²⁺ ions or Sr²⁺ ions and manganese oxide. The graphene-based material may be functionalised with an organic moiety, which is thought may aid in electron transport. It is thought that when in close proximity with one another, Ca²⁺ or Sr²⁺ ions and manganese oxide may function as a catalyst for water oxidation. The function of the graphene-based material is thought to be to conduct electrons between the “catalyst” and the electrolytic circuit. The composite material may be disposed on a substrate, which may be electrically conductive. The substrate may also be electrically non-conductive.

In the context of this specification, the term “comprising” is taken to require the presence of the recited integer(s) but does not preclude the presence of others and does not imply any particular concentration or proportion of the recited integer(s).

In the context of this specification, a graphene-based material is any material comprising sheets of carbon-based extended aromatic, commonly benzenoid, systems. The graphene-based material may comprise other atoms. It may comprise regions which are not aromatic. The sheets of extended aromatic systems may, or may not, be covalently linked to one another. Examples of graphene-based materials include, but are not limited to, graphene, reduced graphene oxide, graphene oxide, partially exfoliated graphite, liquid crystalline reduced graphene oxide (RLCGO), basal plane pyrolytic graphite and carbon nanotubes (single or multi-walled).

In the context of this specification, “coating” may refer to total or partial coverage of a surface. Where the coverage is partial, the coating may be distributed approximately evenly across the entirety of the surface.

The graphene-based material may have a thickness of about 0.1 to about 1000 μm, or about 0.1-5, 5-10, 0.1-1, 1-2.5, 2.5-5, 5-7.5, 7.5-10, 10-20, 20-40, 40-60, 60-100, 100-200, 200-300, 400-500, 500-600, 700-800, 900-1000, 1-100, 200-500, or 500-1000 μm. The thickness may be about 0.5, 1.0, 1.5, 2.0, 3.0, 4.0, 5.0, 6.0, 7.0, 8.0, 9.0, 10, 20, 40, 60, 100, 200, 300, 400, 500, 600, 700, 800, 900 or 1000 μm. The graphene-based material may have a conductance of about 100 to about 500 S/cm, or about 100-250, 250-500, 100-200, 200-300, 300-400 or 400-500 S/cm. The conductance may be about 100, 200, 225, 250, 300, 400 or 500 μm.

In the context of this specification the term “about” is taken to mean±10% of the stated value, unless signified otherwise by the context.

The manganese oxide may be a particular oxide of manganese or it may refer to a mixture of different manganese oxides. Manganese oxides which may be present include, but are not limited to, manganese(II) oxide, manganese(II,III) oxide, manganese(III) oxide and manganese(IV) oxide. Manganese(III) oxy species may also be present. The manganese oxide may be amorphous. In particular, manganese oxide prepared by electrodeposition is likely be amorphous, especially when electrodeposition is performed in the presence of group II metal ions such as Ca²⁺ and/or Sr²⁺. It may be at least about 80% amorphous, or at least about 85, 90 or 95% amorphous, or may be about 100% amorphous. It may have no detectable crystallinity. Amorphicity may be determined by X-ray powder diffraction.

The graphene-based material may be deposited in the form of a partial or complete coating directly on the substrate. Ca²⁺ ions or Sr²⁺ ions may be present on a surface of the graphene-based material. The surface may be the upper surface (i.e. away from the substrate) or the lower surface (i.e. towards the substrate). The Ca²⁺ ions or Sr²⁺ ions may be present on both surfaces. They may be present throughout the graphene-based material. Manganese oxide may be present on an upper of lower surface of the graphene-based material. It is hypothesised that the Ca²⁺ ions or Sr²⁺ ions may engage in intermolecular interactions with the graphene-based material, and/or with the manganese oxide, or with both simultaneously.

The composite material may be disposed as a layer on a substrate. The substrate may comprise any solid material. In some embodiments, the substrate may comprise or consist of an electrically non-conductive material and the graphene-based material may be in contact with the electrically non-conductive material. In other embodiments, the substrate may comprise or consist of an electrically conductive material, which is in contact with the graphene-based material. The substrate may also comprise both an electrically non-conductive material and an electrically conductive material.

The electrically non-conductive material may have a conductivity of less than about 1×10⁻¹⁰ S/m. The conductivity may be between about 0 to about 1×10⁻¹⁰ S/m, or about 0-1×10⁻²⁰, 0-1×10⁻³⁰, 0-1×10⁻⁴⁰, or between about 0-1×10⁻⁵⁰ S/m. The conductivity may be about 1×10⁻¹⁰ S/m, or about 1×10⁻²⁰, 1×10⁻³⁰, 1×10⁻⁴⁰, or about 0-1×10⁻⁵⁰ S/m. The substrate may be comprised of a material which may be flexible or it may be rigid. Non-limiting examples of electrically non-conductive materials suitable for use in the substrate in the present invention are plastics such as polyolefins, polyesters, polyamides or polyacrylates, glass, paper, and ceramic materials such as silica or alumina. A suitable material is poly(ethylene terephthalate).

The electrically conductive material may be any material, such as a metal, which is a good electrical conductor. Good electrical conductors may have a conductivity of about 1×10⁵ S/m to about 1×10¹⁰ S/m. The electrically conductive material may have a conductivity of at least about 1×10⁷, 2.5×10⁷, 5×10⁷, 1×10⁸, 1×10⁹, or about 1×10¹⁰ S/m. Examples of suitable metals include, but are not limited to, copper, gold, silver, aluminium, titanium, or nickel. The electrically conductive material may comprise a mixture or alloy of more than one metal, such as stainless steel. The electrically conductive material may comprise a conductive non-metal such as indium tin oxide, lanthanum-doped strontium titanate, yttrium-doped strontium titanate, doped polyacetylenes, polypyrroles, polyanilines, poly(p-phenylene vinylene), polythiophenes, or mixtures and/or co-polymers thereof.

Where the substrate comprises or consists of an electrically conductive material, the substrate may be formed in a range of possible morphologies and structures. For example, when the substrate is an electrically conductive material it may be a foil, mesh, foam or a customised 3D structure. Another suitable electrically conductive material may be a titanium/expanded graphite electrode. Such structures may be made by additive manufacturing. The electrically conductive material may be a mesh, in particular a metal mesh. A suitable material for a mesh is nickel, or stainless steel. The mesh should be of sufficient thread density to ensure adequate conductivity. A suitable thread density is at least 25 strands/cm. The thread density may be 25 strands/cm, or 30, 40, 50, 60, 70, 80, 90, 100 strands/cm. The electrically conductive material may be a 3D metal foam, for example a nickel or titanium metal foam. Where the substrate is a mesh, the composite material may be disposed on the mesh in the sense that it coats the surface of the fibers of the mesh, or, it may alternatively or additionally be disposed on the mesh in the sense that it coats an upper or a lower surface of the mesh as a whole.

The substrate may comprise an electrically conductive material which is a film (or a foil). A film and a foil are understood to refer to the same structure, with the distinction that a foil is freestanding, in contrast to a film, which is usually disposed on a surface. In the context of this specification, a film (or a foil) is a very thin layer of thickness at most about 1000 μm. A film (or a foil) may have a thickness of at most about 500, 200, 100, 50, 25 or 10 μm. The thickness of the film may be about 0.1 to about 1000 μm, or about 0.1-5, 5-10, 0.1-1, 1-2.5, 2.5-5, 5-7.7, 7.5-10, 10-20, 20-40, 40-60, 60-100, 100-200, 200-300, 400-500, 500-600, 700-800, 900-1000, 1-100, 200-500, 500-1000 μm. The thickness may be about 0.5, 1.0, 1.5, 2.0, 3.0, 4.0, 5.0, 6.0, 7.0, 8.0, 9.0, 10, 15, 20, 25, 30, 35, 40, 45, 50, 60, 70, 80, 90, 100, 200, 300, 400, 500, 600, 700, 800, 900, or 1000 μm.

Where the substrate comprises an electrically conductive material which is a film, the substrate may in some embodiments further comprise an electrically non-conductive material onto which the film is disposed. The electrically conductive film may be applied to the non-conductive material by any suitable method. For example, the electrically conductive film may be applied by sputter coating, vapour deposition or chemical reductive deposition from a solution of soluble metal salt. Commercially available materials such as indium tin oxide-coated plastic may also be suitable as the substrate of the invention.

In its simplest form, the composite material comprises a graphene-based material, group II metal ions, such as Ca²⁺ ions or Sr²⁺ ions, and manganese oxide. In some embodiments, the composite material may be disposed as a layer on a substrate. The substrate is typically an electrically conductive structure such as a mesh or foil, or comprises an electrically conductive film coated on an electrically non-conductive material. The graphene-based material may be in direct physical contact with the substrate, in particular the electrically conductive structure (such as a mesh or film). The group II metal ions such as Ca²⁺ ions or Sr²⁺ ions may be on a surface of the graphene-based material. The group II metal ions such as Ca²⁺ ions or Sr²⁺ ions may be on a surface of the manganese oxide. In some embodiments both the group II metal ions, such as Ca²⁺ ions or Sr²⁺ ions, and the manganese oxide are on a surface of the graphene-based material.

The graphene-based material may be functionalised with an organic moiety comprising an acidic functional group. The composite material may further comprise a second graphene-based material which may be functionalised with an organic moiety comprising an acidic functional group. The composite material may comprise both a functionalised graphene-based material and a functionalised second graphene-based material. Typically, the second graphene-based material will be disposed on an upper (i.e. away from the substrate) surface of the graphene-based material, or it may be disposed on a surface of the group II metal ions such as Ca²⁺ ions or Sr²⁺ ions, or on a surface of the manganese oxide. All the above options share the common feature that all comprise a composite material comprising a graphene-based material, group II metal ions, and manganese oxide. The composite material is optionally disposed as a layer on a substrate, the substrate optionally comprising an electrically conductive material which is in contact with the graphene-based material.

The graphene-based material (as well as the second graphene-based material) may be functionalised with an organic moiety comprising an acidic functional group. The organic moiety is derived from an organic molecule comprising at least one acidic functional group. Acidic functional groups may include carboxylic acids, thiocarboxylic acids, phenols, sulfonic acids, sulfinic acids, nitric acids, phosphinic acids or phosphonic acids. Any functional group which is capable of acting as a proton donor and/or is a Brønsted acid, may be suitable as an acidic functional group of the invention. The acidic functional group may be protonated, deprotonated or partially protonated. The extent of the protonation of the acidic functional group will be dependent on pH. If the acidic functional group is deprotonated the counter ion may be any suitable cation such as sodium, calcium, potassium, lithium or ammonium. The organic molecule may also comprise other functional groups, such as a functional group through which it is attached to the graphene-based material. Examples of suitable organic molecules include suitably functionalised amino acids such as tyrosine or glutamate, or benzoic acids such as terephthalic acid or aminobenzoic acid, aminoalkanoic acids such as aminobutyric acid, aminohexanoic acid, aminooctanoic acid, aminodecanoic acid, aminododecanoic acid (and isomers thereof) or phenols such as 4-hydroxybenzoic acid. ‘Aminoalkanoic acid’ refers to straight or branched saturated carbon chains bearing an amine group and a carboxylate. The graphene-based material may also be directly functionalised with an acidic functional group, for example it may be nitrated or sulfated.

In the context of this specification, “functionalisation” may refer to attachment through covalent or ionic bonds or intermolecular forces. Intermolecular forces may include dipole-dipole interactions, hydrogen bonding or Van der Waals forces. Many approaches are known to the skilled person for functionalising surfaces, including surfaces of graphene-based materials, with acidic functional groups and/or organic molecules. Any suitable method may be used as described below with respect to a method of the invention.

In one form, therefore, there is provided a composite material comprising:
A substrate comprising an electrically non-conductive material having an electrically conductive film (commonly about 1-1000 μm thick) disposed on a surface thereof; and
A layer on said electrically conductive film, said layer comprising manganese oxide, Ca²⁺ ions or Sr²⁺ ions and either:
   A graphene-based material in contact with the film, optionally functionalised with an organic moiety comprising an acidic functional group, or
   A first, unfunctionalised graphene-based material in contact with the film and a second graphene-based material on the graphene-based material, said second graphene-based material being functionalised with an organic moiety comprising an acidic functional group.

In another form, therefore, there is provided a composite material comprising:
A substrate comprising metal mesh; and
A layer coating said metal mesh, said layer comprising manganese oxide, Ca²⁺ ions or Sr²⁺ ions and either:
   A graphene-based material in contact with the mesh, optionally functionalised with an organic moiety comprising an acidic functional group, or
   A first, unfunctionalised graphene-based material in contact with the mesh and a second graphene-based material on the graphene-based material, said second graphene-based material being functionalised with an organic moiety comprising an acidic functional group.

The present invention also relates to a method of producing a composite material, the method comprising first, a. applying a graphene-based material to a substrate, b. treating the product of step a. with Ca²⁺ ions or Sr²⁺ ions and c. applying manganese oxide to the product of step b., wherein the substrate comprises an electrically conductive material. The steps of b. treating with Ca²⁺ ions or Sr²⁺ ions and c. applying manganese oxide may be performed in any suitable order e.g. step b. followed by step c.; or step c. followed by step b. Steps of the method may be performed simultaneously, for example, steps b. and c., or a. and b., may be performed simultaneously.

The graphene-based material may be applied to the substrate by knife coating. Knife coating refers to a known method of fabrication of films, and involves spreading a material over a surface using a blade at a fixed height from the surface of the substrate. By controlling the fixed height, a desired film thickness may be obtained. Liquid crystalline reduced graphene oxide (RLCGO) may be applied onto the substrate by knife coating the substrate with a slurry comprising a mixture of liquid crystalline graphene oxide and hypophosphorous acid. In this process, the graphene oxide is reduced by the hypophosphorous acid, resulting in a coating of liquid crystalline reduced graphene oxide.

The graphene-based material may also be applied to the substrate by dipping the substrate into a solution of the graphene-based material, or a precursor of the graphene-based material (referred to as dip-coating). Reduced liquid crystalline reduced graphene oxide (RLCGO) may be applied onto the substrate by dipping the substrate into aqueous dispersion of liquid crystalline graphene oxide, leaving the coated substrate to dry overnight, then reducing the liquid crystalline graphene oxide at first by heat annealing in an oven at 120° C., then later by chemical reduction with Na₂S₂O₄ in water.

The graphene-based material may also be applied to the substrate by drop coating (also known as drop casting) a solution of the graphene-based material, or a precursor thereof, onto the substrate.

A surface of the material may be treated with group II metal ions such as Ca²⁺ ions or Sr²⁺ ions by immersing the material into an aqueous solution of said metal ions. The group II metal ions may be provided as any suitable, water soluble, salt of the metal. For example, Ca²⁺ may be provided as any suitable water-soluble salt of calcium, or Sr²⁺ may be provided as any suitable water-soluble salt of strontium. In the context of this specification, “soluble” may refer to a material having a solubility of about 1 to about 30 mL/g (in water at 25° C.). The material may have a solubility of less than 1 mL/g. Examples of suitable calcium salts include, but are not limited to, calcium chloride, calcium bromide, calcium acetate, or calcium nitrate. Examples of suitable strontium salts include, but are not limited to, strontium chloride, strontium acetate, or strontium nitrate. The aqueous solution may comprise non-aqueous co-solvents or other organic or inorganic components. The concentration of the group II metal ion in the solution may be about 0.1 M to about 10M, or about 0.1-5, 5-10, 0.1-1, 1-2.5, 2.5-5, 5-7.5 or 7.5-10M. The concentration may be about 0.2, 0.5, 1, 2, 5 or 10M. The immersing may be for a period of about 10 to about 24 h. It may be for about 10-17, 17-24, 10-15, 15-20 or 20-24 h. It may be for about 10, 15, 20 or 24 h. Without wishing to be bound by any particular theory, it is hypothesised that group II metal ions such as Ca²⁺ ions and Sr²⁺ ions are able to bind to and complex with graphene-based material, and may complex with the benzenoid ring system thereof.

Manganese oxide may be coated onto a surface of the graphene-based material by electrodeposition. Electrodeposition refers to a known method of coating materials onto an electrically conductive surface, in which a charged species from a conductive solution is deposited onto an active electrode. This is process is disclosed in detail in, for example, Zhou, F., A. Izgorodin, R. K. Hocking, V. Armel, L. Spiccia, and D. R. MacFarlane, ChernSusChern, 2013, 6(4): p 643-651, which is incorporated herein by cross-reference. As an example, manganese oxide may be deposited from an aqueous solution of sodium nitrate and manganese acetate tetrahydrate, or alternatively from a solution of manganese dichloride. The electrodeposition may be carried out galvanostatically. The electrodeposition may be carried out at a current density of about 100 to about 500 μA/cm², or about 100-250, 250-500, 100-200, 300-400 or 400-500 μA/cm². The current density may be about 100, 200 or 500 μA/cm². The electrodeposition may be carried out for a period of about 1 to about 15 minutes, or about 1-5, 5-10, 10-15, 1-2.5, 2.5-5, 5-7.5, 7.5-10, or 10-15 minutes. The electrodeposition may be carried out for about 1, 2, 5, 10, or 15 min.

The method may further comprise functionalising the graphene-based material with an acidic functional group. The acidic functional group may be part of an organic moiety. The step of functionalising may be carried out prior to step a., such that functionalised graphene-based material is applied to the substrate. Alternatively, the graphene-based material may be applied to the substrate in step a., followed by the step of functionalising.

Where the acidic functional group is part of an organic moiety, the step of functionalising with the organic moiety comprising the acidic functional group may comprise covalent attachment of an organic molecule comprising the acidic functional group. The organic moiety is derived from the organic molecule. Covalent attachment of the organic molecule comprising an acidic functional group may be achieved by any suitable method. One possible procedure is as follows. A linker molecule may be attached to the graphene-based material, followed by attachment of the organic molecule comprising an acidic functional group. For example, the linker molecule could be attached to the surface by radical chemistry e.g. diazonium chemistry, carbene chemistry e.g. using a diazirene, via complexation with a metal or nucleophilic addition e.g. Bingel reaction. The linker molecule may be suitably functionalised in order to facilitate the subsequent attachment of the organic molecule comprising an acidic functional group. Suitable strategies for attaching the organic molecule comprising an acidic functional group may include amide coupling, azide-alkyne Huisgen cycloaddition or Staudinger ligation.

An example of a suitable method for covalent functionalisation is diazonium coupling followed by amide coupling, which may proceed as follows. First, a linker molecule is attached to the graphene-based material (steps (i)-(iii) in FIG. 2). A compound comprising a primary amine and a nitro group is treated with sodium nitrite and hydrochloric acid resulting in the formation of a diazonium salt of the compound. Electrochemical reaction of the diazonium salt with the graphene-based material results in covalent attachment of the linker molecule to the graphene-based material and concomitant reduction of the nitro group to an amine. This process is disclosed in detail in J Nanopart Res 2012, 14:940, p 1-9, Chem Commun 2007, p 1710-1712, ACS Nano 2012, 6, p 2731-2740 and Chem Mater 2005, 17, p 1290-1295, which are incorporated herein by cross-reference. Second, an amide coupling may then be used to attach an organic molecule comprising an acidic functional group to the linker molecule, provided that the organic molecule comprises a carboxylic acid which may take part in the amide coupling. Any suitable amide coupling reagent may be used to effect the amide coupling such as alkyl carbodiimides or 1-hydroxyazabenzotriazole-based reagents.

Another example of a suitable method for covalent functionalisation involves the use of a graphene-based material that is functionalised about an edge thereof. An example of such a material is edge-functionalised graphene (EFG). EFG comprises sheets of graphene having functional groups, typically carboxyl groups, disposed at their edges. These functional groups may further be covalently attached to other molecules, such as an organic molecule comprising an acidic functional group, such that the functional group is part of an organic moiety. The functional group may be an acidic functional group. Said covalently attaching may occur at an edge of the graphene-based material to provide edge functionalised graphene-based material. Edge functionalised graphene based materials may be prepared by literature methods (see, for example, Xiang et al., Adv. Mater. 2016, 28, p. 6253-6261 and references therein). Various graphene-based materials may be edge functionalised, including graphene and graphene oxide. Known methods for preparing EFG and edge-functionalised graphene oxide include covalently grafting 4-aminibenzoic acid (ABA) molecules, as organic molecular wedges, directly onto graphite particles in the presence of poly(phosphoric acid) in N-methyl-2-pyrrolidone, leading to high-yield exfoliation of the 3D graphite into 2D graphene-like sheets, oxidation-exfoliation of graphite with strong oxidising reagents (e.g., H₂SO₄, KMnO₄) followed by reduction, and ball milling graphite with dry ice. The edge functionalisation may be with a range of functional groups or organic moieties including carboxylate or 4-aminobenzoic acid. For example, the graphene-based material may be edge-functionalised with carboxylate groups, which may be prepared by literature methods. This may be followed by amide coupling between the carboxylate groups and an organic molecule comprising both an acidic functional group and an amine. Examples of suitable coupling partners include aminoalkanoic acids, for example aminobutyric acid, aminohexanoic acid, aminooctanoic acid, aminodecanoic acid, aminododecanoic acid (and isomers thereof), amino acids such as tyrosine or glutamate, or aminobenzoic acids. Other suitable coupling partners include molecules comprising an amine and a functional group that may be converted into an acidic functional group. Alternatively, where the graphene-based material is edge functionalised with acidic functional groups, the EFG may itself be a functionalised graphene-based material.

In some embodiments the step of functionalising the graphene-based material comprises functionalising a second graphene-based material followed by applying the functionalised second graphene-based material onto a surface of the composite material. In such embodiments the application of the functionalised second graphene-based material may be carried out between steps a. and b., between steps b. and c. or after step c.

The functionalised second graphene-based material may be applied by drop coating. Drop coating (also referred to as drop casting) refers to a known method for the application of a thin coating to a sample by depositing consecutive drops of a solution on its surface, and allowing the solvent to evaporate.

The composite material of the invention may be used in the fabrication of an electrode, resulting in an electrode comprising the composite material. In general, the fabrication of an electrode will involve attaching a metal wire to the material to enable current to flow between the material and the circuit. For example, the fabrication of an electrode from the composite material may include the following: cutting the composite material to a desired size, attaching a copper wire along an edge of the composite material using silver paste and epoxy glue and coating said wire and paste with epoxy. Other steps may be required.

### EXAMPLES

Deposition of Conductive Reduced Liquid Crystalline Graphene Oxide (RLCGO) on Flexible PET Films (RLCGO-PET).

Liquid crystalline graphene oxide (LCGO) dispersed in water (1.1 wt %, 5-10 μm sheet size) was obtained from the Australian National Fabrication Facility (ANNF) Materials Node at the University of Wollongong. Hypophosphorous acid (50 wt %, 1 mL) was added and mixed into the LCGO solution (10 mL) as the reducing agent. The mixture was then coated onto Multapex PET sheets (75 micron thickness) of dimensions ca. 10 cm×20 cm at room temperature using a doctor blade (0.6 mm blade height). The resulting, wet, brown-black films were dried in air at room temperature for 2 h and then left to dry in an oven at 80° C. overnight. They were thereafter dipped in water to wash away excess reducing agent and allowed to dry thoroughly in air. The resulting flexible, metallic, black graphene films on PET (RLCGO-PET) exhibited an average thickness of 1.5±0.3 μm, with conductances of 225±56 S/cm and resistivities of 40±10 Ω/square. The latter compared well with commercially supplied ITO glass, which displays resistivities of 7-50 Ω/square. The RLCGO-PET were carefully cut into sections having dimensions ca. 2.0×2.5 cm.

Fabrication of Ca-Doped Conductive Reduced Liquid Crystalline Graphene Oxide (RLCGO) on Flexible PET Films (Ca-RLCGO-PET).

The above sheets of RLCGO-PET were prepared by submerging RLCGO-PET samples overnight in a 1 M CaCl₂ solution and thereafter dipping the films into water, followed by air-drying. The Ca-RLCGO-PET sheets were carefully cut into sections having dimensions ca. 2.0×2.5 cm.

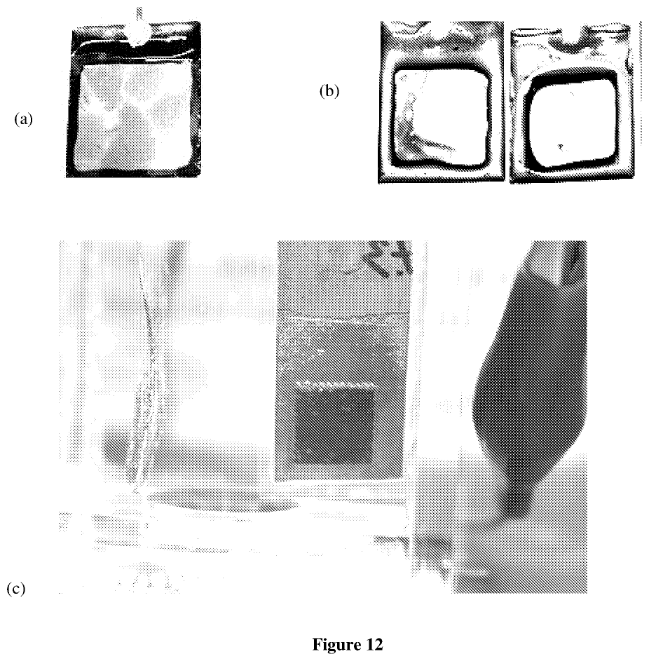

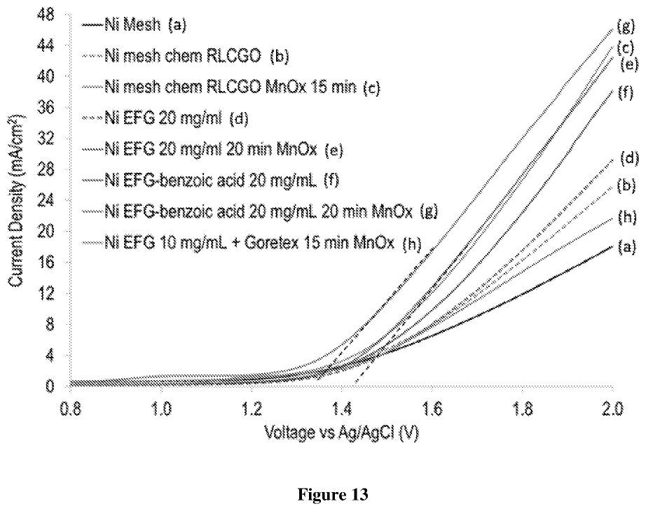

Fabrication of RLCGO-PET and Ca-RLCGO-PET Electrodes. Electrodeposition of MnOₓ Films on RLCGO-PET (MnOₓ—RLCGO-PET and Ca-RLCGO-PET (MnOₓ-Ca-RLCGO-PET)—Shown in FIG. 12.

A stripped copper wire was attached to the edge of each 2.0×2.5 cm RLCGO-PET sheet/Ca-RLCGO-PET sample with silver paste and epoxy glue. The wire and paste were coated with epoxy to prevent contact with electrolyte in later experiments. The electrodes, thus fabricated, were now ready to be electrocoated with MnOₓ. MnOₓ films were electrodeposited on the sheets of RLCGO-PET/Ca-RLCGO-PET. A MnOₓ electro-coating solution was made as follows: A NaNO₃ solution in water (20 mL; 1M) was prepared, to which manganese acetate tetrahydrate (10 mM) was added. Using custom-built, small-volume cells (ca. 1-3 mL), a layer of MnOₓ was thereafter electrodeposited on the RLCGO-PET and Ca-RLCGO-PET electrodes at a constant current density of 200 μA/cm² for 5 min. A three-electrode cell arrangement was used for the electrodeposition, involving a miniature Ag/AgCl reference electrode and a Pt mesh counter electrode (ca. 1.3×1.3 cm). After coating, each electrode was dipped in water to rinse it; it was thereafter gently dried with N₂ gas. The resulting MnOₓ-RLCGO-PET and MnOₓ—Ca-RLCGO-PET, s electrodes were then heat treated at 90° C. for 30 min in air on a hotplate, after which they were stored in a desiccator.

Fabrication of Control Pt-PET Electrodes.

A PET sheet was sputter coated with platinum (100 nm thick). The Pt-coated sheet was then carefully cut into sections having dimensions ca. 2.0×2.5 cm. Stripped copper wire was thereafter attached to the edge of each 2.0×2.5 cm Pt-PET sheet with silver paste and epoxy glue. The wire and paste were coated with epoxy to prevent contact with electrolyte in later experiments.

Electrochemical Experiments.

All electrochemical measurements were carried out using an electrolyte of 0.1 M Na₂SO₄ on an EDAQ466 potentiostat. Linear sweep voltammograms were carried out at a scan rate of 5 mV/s over a range of 0.0-1.6 V (vs. Ag/AgCl). Chronoamperometry was performed at 1.15 V and 1.6 V (vs. Ag/AgCl). The electrochemical cell employed for the experiments comprised a rectangular chamber with fixed positions for the working electrode (MnOₓ—RLCGO-PET and MnOₓ—Ca-RLCGO-PET), reference electrode (Ag/AgCl) and counter electrode (Pt mesh; ca. 1.0×1.5 cm). The distance between the working and counter-electrode was 25 mm.

Results of Electrochemical Experiments.

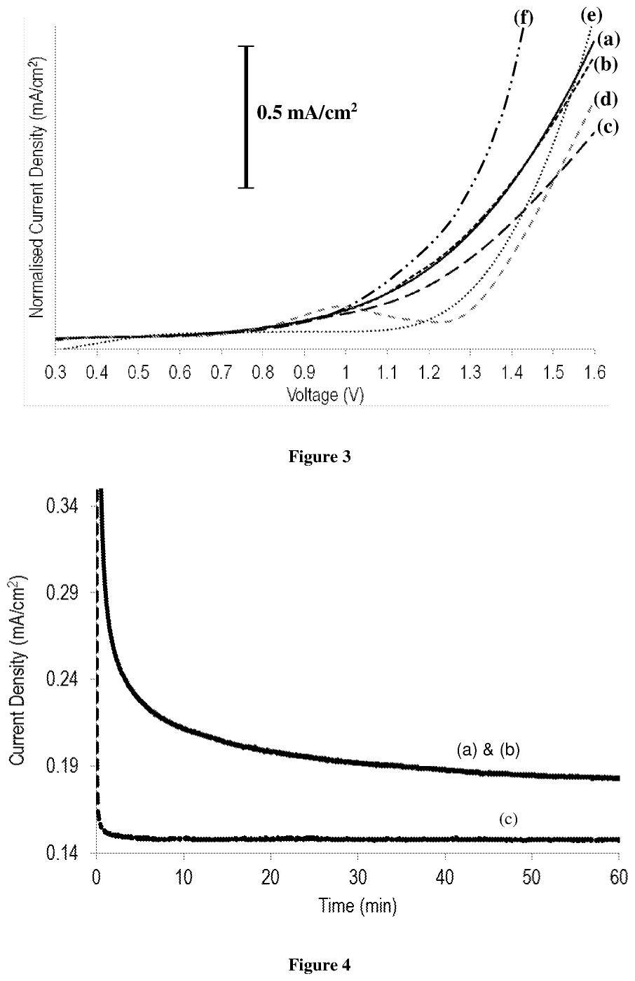

To test the MnOₓ-Ca-RLCGO-PET and MnOₓ—RLCGO-PET electrodes, their electrocatalytic properties as the working anode in a cell containing 0.1 M Na₂SO₄ electrolyte, with an Ag/AgCl reference electrode and Pt mesh counter electrode, were examined. The best performing of these composites were those electro-coated for 5 min. These data are depicted in FIG. 3, which shows representative linear sweep voltammograms of the Mn- and Ca-containing MnOₓ—Ca-RLCGO-PET electrodes (plot (a) in FIG. 3) relative to the Mn-containing but Ca-free MnOₓ-RLCGO-PET (plot (b) in FIG. 3). As can be seen, the two electrodes display essentially identical currents, which are literally coincident over the voltage range examined. They also produce greater currents than the Ca-free and Mn-free control RLCGO-PET electrode (plot (c) in FIG. 3).

The MnOₓ-Ca-RLCGO-PET and MnOₓ—RLCGO-PET electrodes displayed currents under linear sweep conditions that exceeded those of control platinum (FIG. 3(e)) in the region from 0.7 V to at least 1.45 V. When the higher internal electrical resistance of the RLCGO-PET substrate relative to platinum was taken into account (plot (f) in FIG. 3), then the internal resistance-corrected currents of the MnOₓ-Ca-RLCGO-PET and MnOₓ—RLCGO-PET were found to rise as quickly as platinum, but with an overvoltage consistently˜0.2 V lower over the entire range up to 1.6 V vs Ag/AgCl. The conductivity of metallic Pt is higher (˜10⁸ S/cm) than graphene (2×10² S/cm).

Thus, the early onset potential of the RLCGO composites (ca. 0.7 V vs. Ag/AgCl) resulted in the production of currents at voltages well below the onset potential of platinum, which was ca. 1.20 V. Moreover, the internal resistance-corrected currents exceeded platinum at all of the measured voltages.

To establish whether the currents produced by the RLCGO composites below 1.2 V were transient or sustained, the best performing MnOₓ-Ca-RLCGO-PET and MnOₓ—RLCGO-PET electrodes were poised at a fixed voltage of 1.15 V and their performance over time relative to the control Pt-PET was observed. The resulting chronoamperograms are shown in FIG. 4.

As can be seen from FIG. 4, the current of the composites at 1.15 V is not transient or an artefact, but genuine and long-lived. Moreover, it is electrocatalytic, continuing for at least 60 min. Furthermore, it exceeds the catalytic performance of Pt by some margin, even after 1 h of operation. The absolute currents shown in FIG. 4(a)-(b) also do not take into account the higher internal resistance of the graphene layer relative to more conductive platinum layer in FIG. 4(c). While internal resistance-corrected currents for MnOₓ-Ca-RLCGO-PET and MnOₓ—RLCGO-PET (5 min electrodeposition time) were not estimated, they may be greater than the corresponding iR-corrected current for Pt-PET.

Chronoamperograms of the above samples at a fixed, applied voltage of 1.6 V vs. Ag/AgCl were also measured. As can be seen in FIG. 5, the Mn- and Ca-containing MnOₓ-Ca-RLCGO-PET electrodes (plot (a) in FIG. 5) performed somewhat better electrocatalytically (0.41 mA/cm² after 30 min) than the Mn-containing but Ca-free MnOₓ-RLCGO-PET (plot (b) in FIG. 5) (0.35 mA/cm² after 30 min). The Ca-free and Mn-free control RLCGO-PET electrode (plot (c) in FIG. 5) yielded a measured current density of 0.25 mA/cm² after 30 min, which was, nevertheless, greater than that produced by MnOₓ electrodeposited on FTO (0.17 mA/cm² after 30 min). In contrast to FIG. 4, the Pt-PET electrode was substantially more active than even the highest performing of the composites, generating a current of 0.96 mA/cm² after 30 min. A subsequent cyclic voltammogram indicated however, that the corresponding internal-resistance-corrected current for the Mn- and Ca-containing MnOₓ—Ca-RLCGO-PET electrode would likely fall at ca. 0.54 mA/cm² which was still not as high as the Pt-PET electrode.

During the experiments depicted in FIGS. 4 and 5, bubbles of gas could be seen to form on the anodes of all of the coatings examined. To establish the identity of the gas inside the bubbles, measurements were performed at 1.30 V in a specially designed, sealed glass cell through which argon carrier gas was slowly passed. Following extensive, overnight purging to remove all ambient O₂ and prior to application of the test voltage, the argon carrier gas was sampled, using a gas injection loop connected to a dedicated gas chromatograph, and shown to contain no gas other than Ar. The cell was then subjected to the applied voltage, during which time bubbles could be seen to form and release on the electrode surface. After 1 h, the carrier gas was sampled and shown to contain oxygen, which was identified by its GC retention time,

Results with Non-Conductive Substrate Coated with Electrically Conductive Film.

A significant ohmic potential drop occurs in the plane of the electrode, when operating, since the current is collected at the edge. If Sheet Resistance is Rs (Ω/□), then total linear resistance RL, of sheet area L×W (along L direction) is:

R_{L}=Rₛ×L/W(Ω)

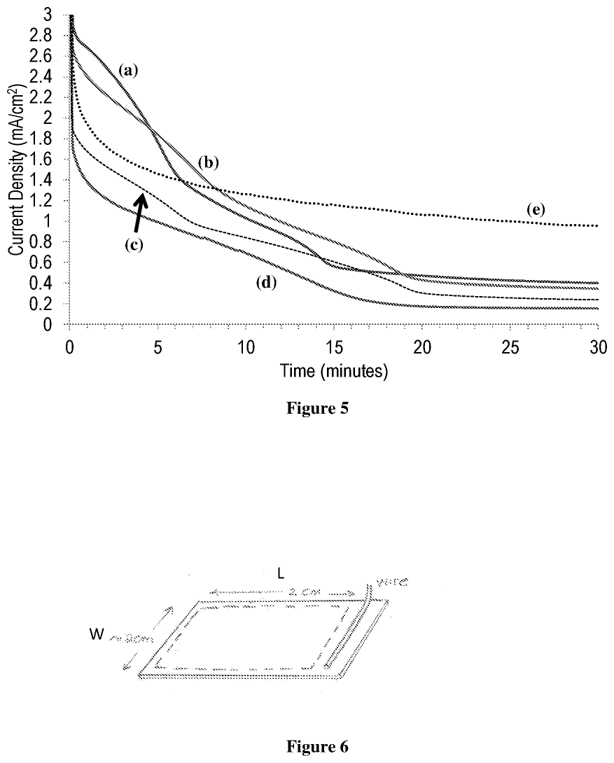

Here L=W (about 2 cm) and R_{L} equals Rₛ=40Ω. The average resistance of the active area along the L direction is half this, ie. R_{L}/2=20Ω. See FIG. 6.
The true, sheet resistance corrected, electrochemical voltage, V (corr'd), corresponding to an operating current density of I (mA/cm²) is therefore:

V(corr'd)=V(measured)−20ILW=V(measured)−80I×10⁻³(V)

This is shown in FIG. 3. The current rises with corrected voltage as quickly as Pt, but with an overvoltage consistently about 0.2 V lower. The observed and corrected voltage for Pt should be essentially the same, as the conductivity of metallic Pt is high (about 10⁸ S/cm), compared to about 2×10² S/cm for the graphene-based material. This analysis is considered to be a good 1st order estimate.

This indicates that results with a substrate coated with an electrically conductive film, (e.g. Cu film on plastic/glass etc.), so that the current pathway length through the graphene-based material is minimised (e.g. film thickness of about 1.5 μm), are likely to match the internal resistance-corrected results of FIG. 3.

Fabrication of MnOₓ Electrodes on Metal Substrates.

In a typical experiment the substrate (nickel foil, nickel mesh, or stainless steel mesh) was cleaned by sonication in acetone or isopropyl alcohol for 30 min. These were then plasma cleaned for 15 min and coated by dipping the material into aqueous dispersion of LCGO (approx. 2 mg/g for the nickel substrates and 3.6 mg/g for the stainless steel substrate, mg of LCGO per g of total dispersion). The coated substrates were left to dry overnight. Where applicable, the LCGO was reduced at first by heat annealing in an oven at 120° C., later by chemical reduction with Na₂S₂O₄ in water (50 mg/mL) at 95° C. for one hour. The coated substrate was rinsed twice in milli-Q water and air dried. Afterwards the substrate material was fashioned into electrodes by lamination and the active area confined to 1 cm².

The electrodes were then again plasma cleaned for 15 min before MnOₓ deposition by the established method (Zhou, F., A. Izgorodin, R. K. Hocking, V. Armel, L. Spiccia, and D. R. MacFarlane, ChemSusChem, 2013, 6(4): p. 643-651, incorporated herein by cross-reference). An aqueous solution of Mn (CH₃COO)₂.4H₂O (10 mM) and NaNO₃ (1M) was prepared fresh for each deposition experiment. This was then transferred to a simple 3 electrode cell prepared earlier (a smaller version of the large test box) where the sample substrate was the working electrode set to a galvanostatic current of 200 μA/cm², with a Ag/AgCl reference and platinum mesh counter electrode. The standard protocol was 10 min deposition time, after which the electrode was taken out of solution and submerged in milli-Q water to rinse it. The electrode was air dried and then heated in an oven to 90° C. in air for 30 min.

Fabrication and Testing of Ca-MnOₓ Electrodes on Steel Mesh Substrate.

A MnOₓ-Ca-RLCGO electrode on steel mesh substrate was fabricated using the methods described above, with 10 min MnOₓ deposition time.

Testing of Electrodes Fabricated on Metal Substrates.

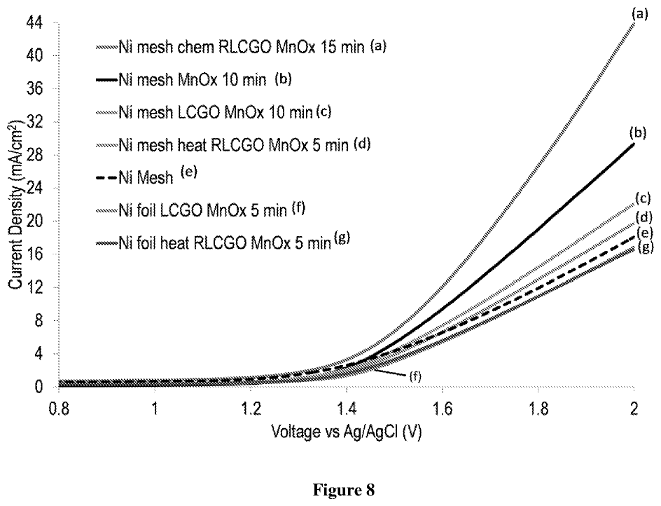

The finished electrode samples were tested in an electrochemical cell using aqueous Na₂SO₄ (0.1M) with the sample as working electrode, an Ag/AgCl reference and platinum counter electrode (see FIG. 8). The samples were tested via linear scan voltammetry (LSV) in the range of 0-2 V at a rate of 20 mV/s. This was to examine the onset potential and current response of the sample over the range where water oxidation is to be expected (approx. 1.3 V onwards), as well as obtain an estimate of the overall performance level. Typically numerous sweeps were recorded (3-5) and the final sweep analysed—which is when the sample has reached a more stable state between individual cycles. Of the samples prepared in this work so far, the nickel mesh electrodes with chemically reduced LCGO and 15 min MnOₓ deposition were found the highest performing (see FIG. 8). The foil electrodes exhibited near immediate detachment of the MnOₓ layer once gas bubbles started forming, which soon degraded the film until only the nickel substrate remained. In the case of the drop cast graphene experiment, which was also explored as a possible graphene deposition method, the deposited layers completely detached when exposed to water. The mesh electrodes proved more resilient with regard to MnOₓ attachment, as well as overall better performance. The water oxidation activity markedly increased when MnOₓ was deposited on chemically reduced RLCGO, although the underlying nickel substrate was found to visibly darken when subjected to the reducing agent, and showed somewhat changed behaviour.

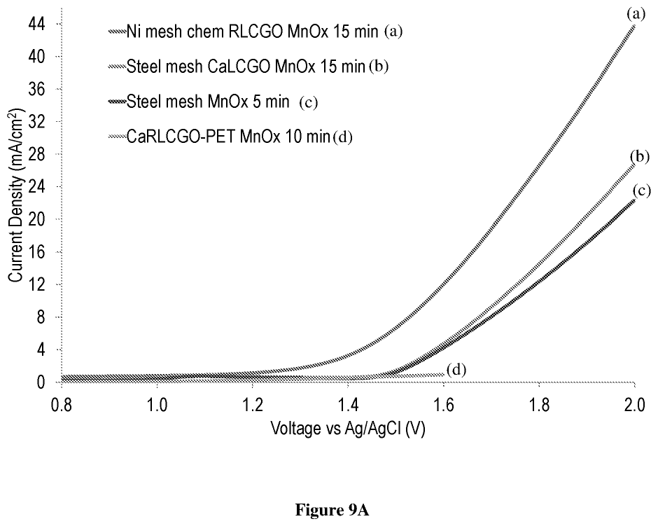

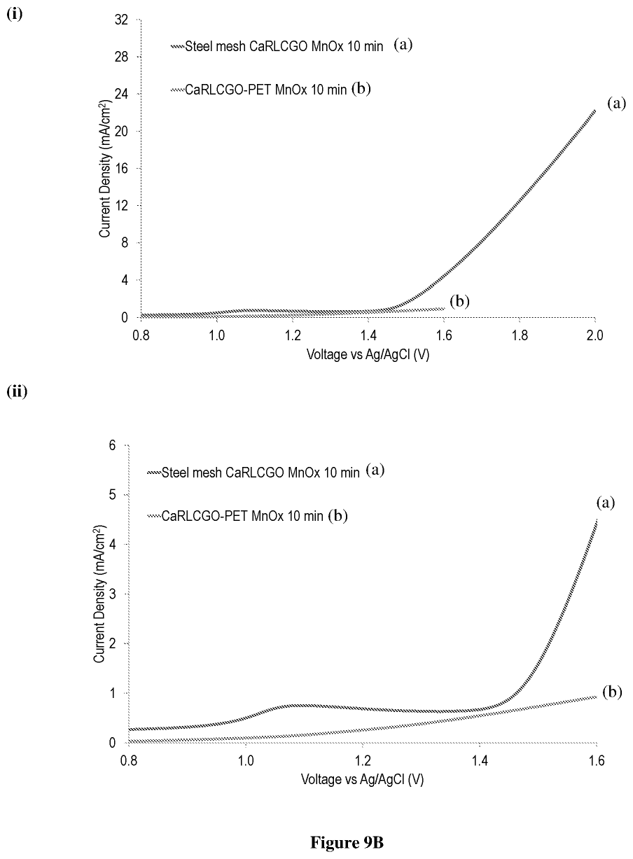

A performance comparison of electrodes on Ni substrates is shown in FIG. 8. A comparison of electrodes on Ni mesh, steel mesh and PET substrates is shown in FIG. 9A. A comparison of the performance of a MnOₓ-Ca-RLCGO steel mesh electrode and a MnOₓ-Ca-RLCGO-PET electrode (also prepared with 10 min MnOₓ deposition time) is shown in FIG. 9B.

Functionalised Composite Material.

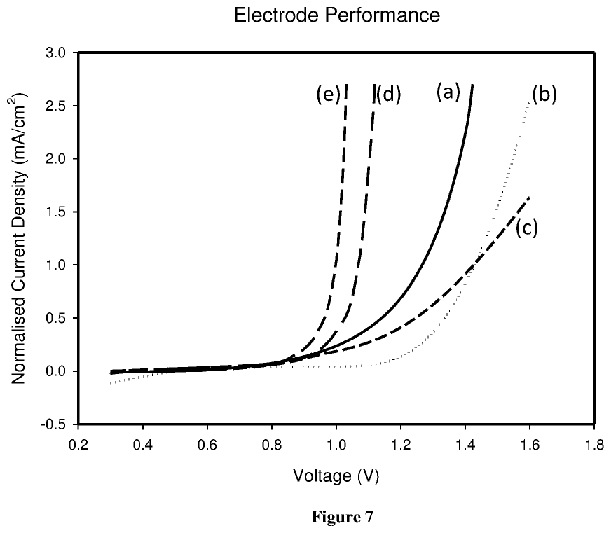

FIG. 7 compares the internal-resistance corrected MnOₓ-Ca-RLCGO-PET electrode with several other systems. Shown also are two examples of the ultimate, upper limit expected performance from composite materials incorporating functionalisation with an organic molecule comprising an acidic functional group, if the surface assembled Mn/Ca sites are able to operate with a (maximum) catalytic efficiency of the natural system (curves (d) and (e)). Performances for two likely site densities are shown, 10¹⁵ and 10¹⁴ sites/cm² (i.e. a 100 Å² footprint/organic moiety in the latter case). The former is expected to require some texturing of the surface to increase site density. Curves (d) and (e) are derived from the known maximal turnover rate of the natural OEC system, ˜10³/s. The natural Mn OEC catalytic cluster is known to have a footprint of ˜100 Å² and 10¹⁴ sites/cm² due to the close packing of catalytic clusters on a flat surface. If the surface is textured (e.g. with carbon nanotubes oriented perpendicular from the surface, effective densities/cm² of electrode can be significantly higher (for example by a factor of 10).

The performance decline with time seen in the current MnOₓ-Ca-RLCGO-PET system, which uses unfunctionalised liquid crystalline reduced graphene oxide, may be due to the progressive conversion of the initially deposited, more active hydrated Mn(III-IV) oxy/hydroxy species, into MnO₂ nanoparticles. The latter are substantially less active in water oxidation, but more thermodynamically stable. The inventors hypothesise that the natural, OEC catalytic site uses carboxylate binding of the MnOₓ centre to the protein cavity, as it prevents this irreversible conversion to MnO₂ like forms.

Fabrication of Functionalised Reduced Graphene Oxide (FRGO) Electrode.

Reduced graphene oxide (RGO) produced by heat annealing of graphene oxide was functionalised using a literature diazonium formation method (Wang, A., W. Yu, Z. Huang, F. Zhou, J. Song, Y. Song, L. Long, M. Cifuentes, M. Humphrey, L. Zhang, J. Shao, and C. Zhang, Covalent functionalization of reduced graphene oxide with porphyrin by means of diazonium chemistry for nonlinear optical performance. Vol. 6. 2016. 23325, incorporated herein by cross-reference). A typical experimental procedure for coupling 4-aminophenol is as follows. An aryldiazonium ion solution was prepared according to the following method. Sodium nitrite (0.117 g), 4-aminophenol (0.154 g) and sodium hydroxide (0.0398 g) were dissolved in deionised water (9 mL). The solution was then added dropwise to dilute hydrochloric acid solution (0.1 mol L⁻¹, 6 mL) in an ice bath with stirring. The pH of the resultant mixture was adjusted to acidic by adding further hydrochloric acid solution. The aryldiazonium ion solution was added dropwise to a previously-prepared suspension of purified RGO (16 mg) in deionised water (14 mL, dispersed by ultra-sonication) with stirring. The resultant mixture was kept in the ice bath for 7 h and then at room temperature for a further 8 h. The contents were filtered through a 0.45 μm nylon membrane, and the collected solid was washed repeatedly with deionised water, ethanol and acetone to remove excess diazonium salts. This afforded the phenol-functionalized RGO hybrid as a black solid, which was vacuum-dried at room temperature for 24 h.

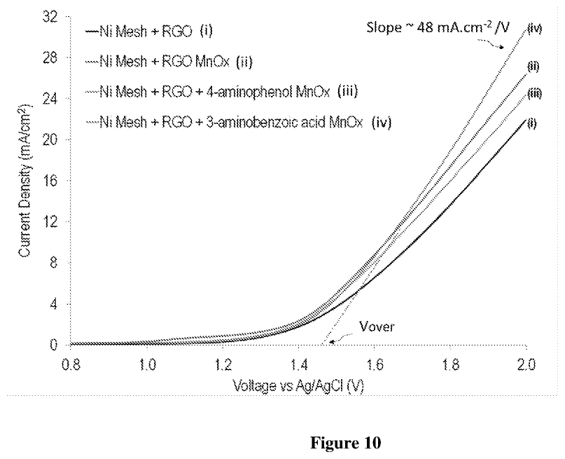

Diazo-derivatives of 4-aminophenol, or 4-aminobenzoic acid, or 3-aminobenzoic acid were formed according to the method of Wang et al, referenced above, and coupled to RGO dispersed in water by ultra-sonication. The mixture was stirred in an ice bath over several days. These functionalisation groups are of the type expected to provide OEC like ligation (carboxylate, phenolic) to Mn. The dispersed, functionalised RGO was then dip-coated onto Ni mesh electrodes and MnOx electro-deposited, where appropriate, as described above. The performance of electrodes comprising FRGO is shown in FIG. 10. Overall the results were less than anticipated, based on the data in FIG. 8 (note vertical scale difference). The base, Ni/(RGO) performance is similar in both cases, but the substantial enhancement brought by MnOx deposition seen for the chemically reduced GO is not seen with the heat annealed RGO. In addition, only modest enhancement of the RGO response with the functionalisations studied to date was observed (3-amino benzoic acid being the best). The inferred over-potential intercept (˜1.45 V) for the latter is similar to that for the chemically reduced RLCGO/MnOx system, but the linear region limiting slope is much less (˜48 mA·cm⁻²/V). The inventors infer that MnOx does not deposit effectively, at least in a suitably active form, on the heat annealed RGO, compared to its binding on the chemically reduced material.

Fabrication of Electrode with Edge Functionalised Graphene (EFG).

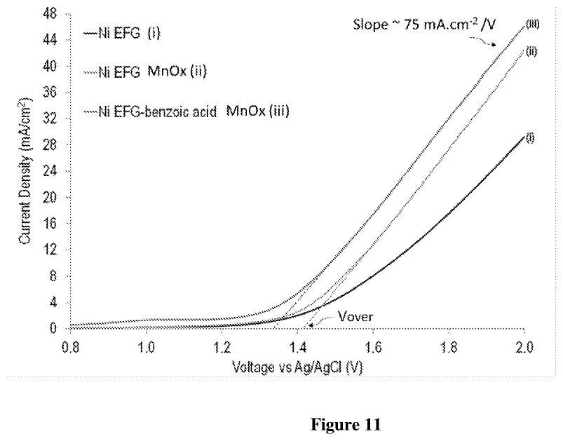

EFG which was functionalised with carboxylate groups was obtained from the Australian National Fabrication Facility (ANNF) Materials Node at the University of Wollongong and aminohexanoic acid, tyrosine, and para-aminobenzoic acid were covalently attached by amide coupling. Dispersions of the functionalised graphene species in water were dip coated onto nickel mesh, then MnOₓ electro-deposited. If necessary, the dispersion concentration was modified, to improve graphene dispersal in water (particularly in the case of the benzoic acid functionalised species). The performance of electrodes comprising FRGO is shown in FIG. 11. The base substrate Ni/EFG CV behaviour is quite similar to that of the corresponding base substrate electrodes in FIGS. 8 and 10, with the RLCGO and the heat annealed RGO. However MnOx deposition on the EFG surface substantially enhances electrode performance, both in over-potential (˜1.42 V) and high voltage limiting slope (˜75 mA·cm-2/V), to a degree very similar, quantitatively, to that seen in FIG. 8 for RLCGO. Further, additional benzoic acid functionalisation of the EFG, with MnOx coating, gives the best performance yet achieved. The over-potential is in this case˜1.33 V and the limiting slope˜75 mA·cm⁻²/V. The hexanoic acid functionalised EFG did not perform better, overall, than unmodified EFG.

A summary of samples prepared by the above methods is shown in the following table. Recited solvents and concentrations refer to conditions for depositing graphene based material on to substrate e.g. ‘Ni foil tyrosine EFG in ethanol 3 mg/mL’ means a 3 mg/mL solution of tyrosine EFG in ethanol was prepared and deposited onto Ni foil. ‘EFG’ refers to edge functionalised graphene without further modification, i.e. bearing only carboxy groups on the edges of the graphene sheet. ‘EFG-PEG’ refers to a mixture of EFG and PEG, typically 1:1.

| | Current density (mA/cm²) at 2.0 V | | | | |
|---|---|---|---|---|---|
| | MnOₓ Deposition time | | | | |
| Substrate + graphene based material | Blank | 5 min | 10 min | 15 min | 20 min |
| Ni foil | 15.44 | 14.70 | 17.04 | | |
| Ni foil + LCGO | | 15.70 | 13.62 | | |
| Ni foil + RLCGO (heat anneal) | | 16.56 | 15.01 | | |
| Ni foil + LCGO (drop cast) | | 14.35 | | | |
| Ni foil + RLCGO (drop cast, heat anneal) | | 14.85 | | | |
| Steel mesh | 18.33 | 22.30 | 19.40 | 18.11 | 16.20 |
| Steel mesh reduced | 22.55 | | | | |
| Steel mesh LCGO | 20.43 | 17.85 | 11.10 | 20.52 | 12.41 |
| Steel mesh RLCGO | 17.68 | 18.09 | 21.16 | 18.58 | 22.42 |
| Steel mesh CaRLCGO | 18.21 | | 22.18 | 22.18 | |
| Steel mesh CaLCGO | 17.65 | | 20.32 | 26.72 | |
| Ni mesh | 18.04 | 21.61 | 29.31 | | |
| Ni mesh (chem reduction) | 25.78 | | | | |
| Ni mesh + LCGO | 19.47 | 18.65 | 22.06 | | |
| Ni mesh + RLCGO (heat anneal) | 20.63 | 19.72 | 18.27 | | |
| Ni mesh + RLCGO (chem reduction) | 25.74 | | 39.65 | 43.82 | |
| Ni mesh CaLCGO | 29.73 | 35.26 | 36.03 | 29.67 | 35.95 |
| Ni mesh EFG | 31.14 | 30.27 | 29.10 | 39.25 | 33.55 |
| Ni foil + tyrosine EFG in ethanol 3 mg/mL | 27.88 | 25.60 | 32.40 | 27.51 | 22.85 |
| Ni foil + tyrosine EFG in ethanol 6 mg/mL | 23.94 | 29.88 | 28.72 | 37.17 | 33.97 |
| Ni foil + tyrosine EFG in ethanol 10 min mg/mL | 29.60 | 31.00 | 33.76 | 29.89 | 29.42 |
| Ni foil + tyrosine EFG in water 3 mg/mL | 26.39 | 22.10 | 29.39 | 32.81 | 25.98 |
| Ni mesh + RGO | 21.92 | 23.55 | 22.82 | 26.36 | 25.34 |
| Ni mesh + RGO + 4-aminophenol | 21.28 | 23.89 | 22.46 | 24.32 | 20.82 |
| Ni mesh + RGO + 4-aminobenzoic acid | 23.74 | 23.89 | 22.46 | 24.32 | 20.82 |
| Ni mesh + RGO + 3-aminobenzoic acid | 24.43 | 25.39 | 23.87 | 30.74 | 24.17 |
| Ni foil + EFG (10 mg/mL) | 26.89 | | | | |
| Ni foil + EFG (10 mg/mL) 1 | | | | 30.99 | |
| Ni foil + EFG (10 mg/mL) 2 | | | | 34.76 | |
| Ni foil + EFG (10 mg/mL) 3 | | | | 32.44 | |
| Ni foil + EFG (20 mg/mL) | 29.20 | 27.46 | 31.27 | 26.74 | 42.42 |
| Ni foil + EFG-PEG (10 mg/mL) | 26.34 | 35.48 | 31.10 | 29.40 | 28.94 |
| Ni foil EFG-aminohexanoic acid 20 mg/mL | 35.10 | 41.07 | 29.31 | 41.96 | 38.52 |
| Ni foil EFG-aminobenzoic acid 20 mg/mL + NaOH | 37.04 | 39.63 | 37.89 | 39.36 | 42.50 |
| Ni foil EFG-aminobenzoic acid 10 mg/mL | 36.25 | 43.60 | 35.88 | 35.43 | 39.33 |
| Ni foil EFG-aminobenzoic acid 20 mg/mL | 38.08 | 40.17 | 42.12 | 42.22 | 46.08 |

1. A composite material comprising a graphene-based material layer, a manganese oxide layer, and a group II metal ion layer, wherein the manganese oxide layer is proximate to the group II metal ion layer, and wherein the manganese oxide is amorphous.

2. The composite material of claim 1, wherein said group II metal ions are Ca²⁺ ions, Sr²⁺ ions, or a mixture thereof.

3. The composite material of any one of claims 1 to 2 wherein the graphene-based material comprises any one or more of graphene, reduced graphene oxide, liquid crystalline reduced graphene oxide, basal plane pyrolytic graphite and carbon nanotubes.

4. The composite material of any one of claims 1 to 3 wherein the graphene-based material has a thickness of about 0.1 to about 1000 μm.

5. The composite material of any one of claims 1 to 4 wherein the graphene-based material has a conductance of about 100 to about 500 S/cm

6. The composite material of any one of claims 1 to 5 wherein the graphene-based material is functionalised with an organic moiety comprising an acidic functional group.

7. The composite material of claim 6, wherein said graphene-based material is functionalised with an organic moiety comprising an acidic functional group at an edge of the graphene-based material, to provide edge functionalised graphene-based material.

8. The composite material of claim 6 or claim 7 wherein the organic moiety is an amino acid.

9. The composite material of claim 8 wherein the amino acid is tyrosine or glutamate.

10. The composite material of claim 8, wherein the amino acid is an aminoalkanoic acid.

11. The composite material of claim 6 or claim 7, wherein the organic moiety is an aminophenol or an aminobenzoic acid.

12. The composite material of any one of claims 1 to 11, wherein said composite material is disposed as a layer on a substrate.

13. The composite material of claim 12, wherein the substrate comprises an electrically conductive material which is in contact with the 0graphene-based material.

14. The composite material of claim 13, wherein the electrically conductive material is a film.

15. The composite material of claim 14, wherein the substrate further comprises an electrically non-conductive material and the film is disposed thereon.

16. The composite material of claim 15, wherein the electrically non-conductive material is poly(ethylene terephthalate).

17. The composite material of any one of claims 14 to 16, wherein the film comprises copper, silver, aluminium, nickel, stainless steel, or a mixture thereof.

18. The composite material of claim 13 wherein the electrically conductive material is a metal mesh.

19. The composite material of claim 18 wherein the metal is nickel or stainless steel.

20. A method of producing a composite material, the method comprising:
a. Applying a graphene-based material to a substrate,
b. Treating the product of step a. with group II metal ions, and
c. Applying manganese oxide to the product of step b.,
wherein step c. is such that the applied manganese oxide is amorphous.

21. The method of claim 20, wherein said group II metal ions are Ca²⁺ ions, Sr²⁺ ions, or a mixture thereof.

22. The method of claim 20 or claim 21 wherein the graphene-based material comprises any one or more of graphene, reduced graphene oxide, liquid crystalline reduced graphene oxide, basal plane pyrolytic graphite or carbon nanotubes.

23. The method of any one of claims 20 to 22 wherein step a. comprises dip-coating said substrate.

24. The method of any one of claims 20 to 23 wherein step a. is such that the applied graphene-based material has a thickness of about 0.1 to about 1000 μm.

25. The method of any one of claims 20 to 24 wherein step a. is such that the applied graphene-based material has a conductance of about 100 to about 500 S/cm

26. The method of any one of claims 20 to 25 wherein step b. comprises immersing the product of step a. in an aqueous solution comprising group II metal ions.

27. The method of any one of claims 20 to 26 wherein step c. comprises electrodeposition of manganese oxide onto said surface.

28. The method of any one of claims 20 to 27 further comprising functionalising the graphene-based material with an organic moiety comprising an acidic functional group.

29. The method of claim 28, wherein the functionalising with an organic moiety comprising an acidic functional group comprises covalently attaching an organic molecule comprising an acidic functional group to the graphene-based material.

30. The method of claim 29, wherein said covalently attaching occurs at an edge of the graphene-based material to provide edge functionalised graphene-based material.

31. The method of claim 29 wherein covalently attaching said organic molecule comprises attaching an amine linker molecule to the graphene-based material through a diazonium coupling, followed by attachment of the organic molecule comprising an acidic functional group to said linker molecule by an amide coupling.

32. The method of any one of claims 28 to 31 wherein the organic moiety or molecule is an amino acid.

33. The method of claim 32 wherein the amino acid is tyrosine or glutamate.

34. The composite material of claim 32, wherein the amino acid is an aminoalkanoic acid.

35. The method of any one of claims 28 to 31 wherein the organic moiety or molecule is an aminophenol or an aminobenzoic acid.

36. The method of any one of claims 20 to 35, wherein the substrate comprises an electrically conductive material which is in contact with the graphene-based material.

37. The method of claim 36, wherein the electrically conductive material is a film.

38. The method of claim 37, wherein the substrate further comprises an electrically non-conductive material and the film is disposed thereon.

39. The method of claim 38, wherein the electrically non-conductive material is poly(ethylene terephthalate).

40. The method of any one of claims 37 to 39, wherein the film comprises copper, silver, aluminium, nickel, stainless steel, or a mixture thereof.

41. The method of claim 36 wherein the electrically conductive material is a metal mesh.

42. The method of claim 41 wherein the metal is nickel or stainless steel.

43. A composite material produced by the method of any one of claims 20 to 42.

44. An electrode comprising the composite material of any one of claim 1 to 19 or 43.

45. A method of electrolysing water, the method comprising at least partially immersing the electrode of claim 44 and a counter electrode in an aqueous solution and applying a voltage between said electrodes.

46. Use of the composite material of any one of claim 1 to 19 or 43 in the fabrication of an electrode.

47. Use of the electrode of claim 44 for the electrolysis of water.

48. A method of generating H₂, the method comprising at least partially immersing the electrode of claim 44 and a counter electrode in an aqueous solution and applying a voltage between said electrodes.
